(19) United States
(12) Patent Application Publication
(10) Pub. No.: US 2005/0080572 A1
(43) Pub. Date: Apr. 14, 2005

(54) METHOD OF DEFECT CONTROL

(76) Inventor: Long-Hui Lin, Hsin-Chu Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,783

(22) Filed: Mar. 25, 2004

(30) Foreign Application Priority Data
Oct. 13, 2003 (TW) 092128336

(51) Int. Cl. G06F 19/00

(52) U.S. Cl. 702/35

(57) ABSTRACT

A method of defect control by daily checking. First, a patterned wafer with a plurality of first defects is provided. After performing a semiconductor process, which generates a plurality of second defects on the wafer, a defect detecting process is performed to detect the first defects and the second defects. Then, the first defects and the second defects are divided according to a predetermined database. The second defects are classified into a plurality of defect types according to the predetermined database.

### BACKGROUND OF INVENTION

1. Field of the Invention

The present invention relates to a method of defect control, and more particularly, to a method of defect control by using a patterned wafer as a monitor wafer in a semiconductor fabricating process.

2. Description of the Prior Art

In the semiconductor fabricating process, some small particles and defects are unavoidable. As the size of devices shrinks and the integration of circuits increases gradually, those small particles or defects affect the property of the integrated circuits more seriously. For improving the reliability of semiconductor devices, a plurality of tests are performed continuously. According to the test result, process parameters are tuned correspondingly to reduce a presence of defects or particles so as to improve the yield and reliability of the semiconductor fabricating process.

Please refer to FIG. 1, which is a schematic diagram of a conventional semiconductor fabricating process. As shown in FIG. 1, a semiconductor wafer is processed with a plurality of fabricating processes. Typically, thousands of fabricating processes are carried out in a fab. For clarity, only several fabricating processes are illustrated in FIG. 1 for describing the method of defect control in prior art. As shown in FIG. 1, a process A 10, a process B 20, a process C 30, a process D 40, and a process E 50 represent five semiconductor fabricating processes which are performed by different machines. For improving the reliability and stability of each process, some steady repairs or maintenances are necessary for these machines. For example, after operating for a period of time, each machine must be shut down for performing a preventative maintenance (PM). Even during an operation state, a daily check is still carried out by using some bare wafers as a monitor wafer. Those bare wafers experience each fabricating process, such as the aforementioned process A 10, process B, 20, process C 30, process D 40, and process E 50, with the same process parameters and then a defect analysis is performed to judge if these machines are qualified for carrying out these fabricating processes.

Besides the examination of machines status, a defect examination is also performed for inline products so as to maintain the reliability and stability of products. Since the fabrication of a semiconductor wafer is very complex and typically includes thousands of fabricating processes, those fabricating processes are normally grouped into a plurality of stations and each of them comprising several fabricating processes. Then, sampling product wafers are performed for defect examination by each station. For example, the defect detection 60 is used to examine defects occurring in the processes A, B, C, and D. Please refer to FIG. 2, which is a schematic diagram of a conventional method of defect detection 60. As shown in FIG. 2, the defect detection 60 detects defects on the wafer by performing a pre-scan process 110 before one or several predetermined semiconductor processes 120 and performing a post-scan process 130 after the semiconductor processes 120, respectively. By comparing the result of the pre-scan process 110 and that of the post-scan process 130, the defects generated during the semiconductor fabricating process 120 can be found. These are so-called adding defects 140. Then, those adding defects 140 are manually examined by engineers during the SEM review 150 for continuing a following root cause analysis. After finishing the root cause analysis, process parameters are tuned properly according to the result of the root cause analysis to reduce defects generated by the same cause.

Conventional technology has many disadvantages of using bare wafers to perform a daily check for machines or a sampling examination by grouping for inline products. For example, the former will waste a lot of bare wafers and reduce the throughput of the production lines, leading to a significant increase in the fabrication cost. In addition, since only some limited bare wafers are used as a tool monitor, it is hard to find the integrating defects, which are caused by a plurality of processes, in the bare wafer test. It is also hard to detect the occasional excursion case, which happens easily in mass production. Though those occasional excursion cases can be detected sometimes indeed, it still cannot provide enough data to perform defect analysis and solve problem of the excursion case.

The latter has complex steps. It needs to scan twice (the pre-scan process 110 before the semiconductor process 120 and the post-scan process 130 after the semiconductor process 120) to obtain the adding defects 140. After obtaining the adding defects 140, the SEM review 150 with a heavy loading is still required. Since much effort and time are necessary in the SEM review 150, a sampling examination by grouping is performed instead of a large scale defect examination for all processes. In this situation, after a defect is generated, a plurality of semiconductor processes are still performed before the defect detection 60. It is obvious that the sensitivity of the defect detection 60 is reduced so that the performance of the defect control is deteriorated thereby. In addition, the conventional defect detection 60 takes a long response time. For example, once an excursion case happens in the product wafer, it normally takes several days to analyze the defects, judge the defect source, and adjust process parameters in advance for reducing those defects. However, it is obvious that all the product wafers made in these days may have the same type of defects. It is a fatal problem in mass production steps, leading to a significant yield loss and high fabrication cost. Furthermore, as the size of wafers increases from 8 inches to 12 inches, this problem becomes even more serious.

Thus, a method of defect control with low cost, fast response and high sensitivity is required to solve the aforementioned problems.

### SUMMARY OF INVENTION

It is therefore a primary objective of the claimed invention to provide a method of defect control with low cost, fast response and high sensitivity to solve the aforementioned problems in the prior art.

In a preferred embodiment of the claimed invention, a method of defect control for a semiconductor process is disclosed. First, a patterned wafer is provided. After performing the semiconductor process toward the pattern wafer, a defect detection is performed. A predetermined database is utilized to classify the detected defects automatically for filtering the prelayer defects which are generated before the semiconductor process. It further separates the residual defects, which is caused by the semiconductor process, into killer defects and non-killer defects according to their influence on yield. When a killer defect is detected, an alarm with a defect analysis report is automatically delivered to a responsible person, i.e. an engineer, to assist him to correct process parameters and eliminate the excursion case.

It is an advantage of the claimed invention that a product wafer can be used for defect detection and an automatic defect classification is carried out by a predetermined database. Thus, the prelayer defects and the adding defect can be separated without a pre-scan process. In addition, by separating killer defects and non-killer defects, it can further reduce the loading of the SEM review, shorten the response time, and improve the sensitivity of the defect detection, thereby improving yield and reliability of products.

These and other objectives of the claimed invention will no doubt become obvious to those of ordinary skill in the art after reading the following detailed description of the preferred embodiment which is illustrated in the various figures and drawings.

### BRIEF DESCRIPTION OF DRAWINGS

FIG. 1 and FIG. 2 are schematic diagrams of a method of defect control for a semiconductor process in the prior art.

FIG. 3 and FIG. 4 are schematic diagrams of a method of defect control for a semiconductor process in the present invention.

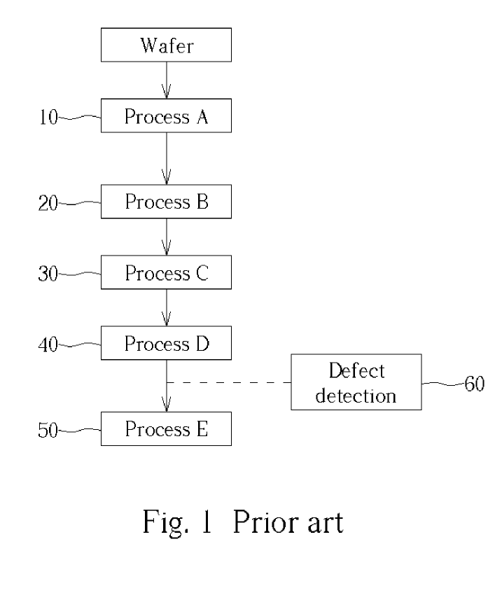

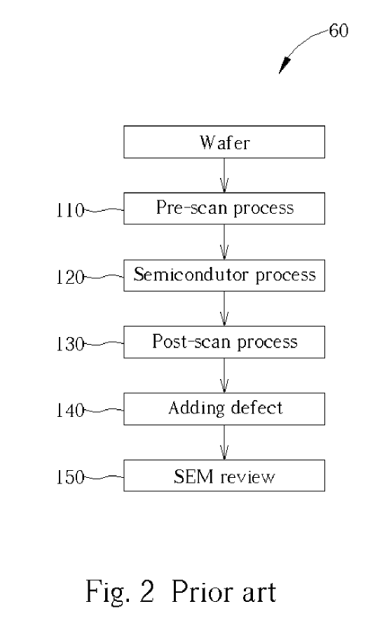

### DETAILED DESCRIPTION

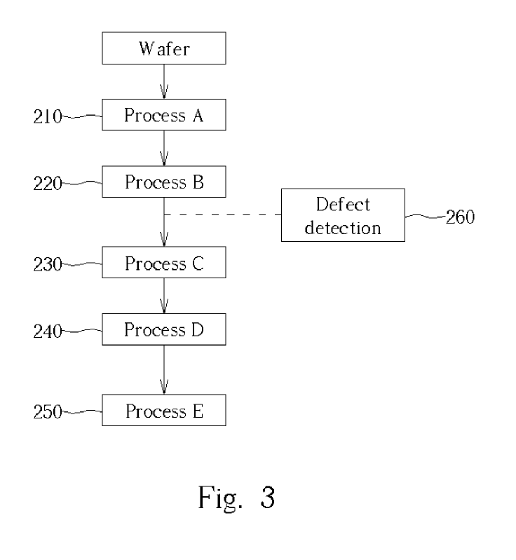

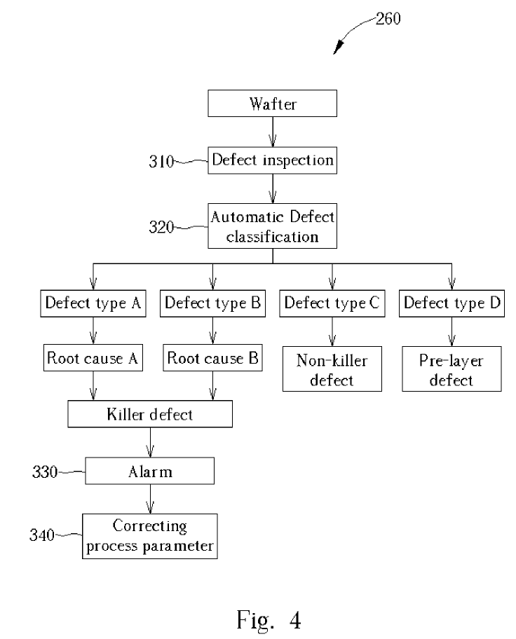

Please refer to FIG. 3 and FIG. 4, which are schematic diagrams of a method of defect control in the present invention. As shown in FIG. 3, in the fabricating procedure, five semiconductor processes, which are process A 210, process B 220, process C 230, process D 240, and process E 250, are performed for a wafer. Each semiconductor process makes a plurality of defects on the wafer. The process B is illustrated in the following to describe the method of defect control of the present invention. First, it is noted that an additional bare wafer is not required in the present invention. The test in the present invention is carried out by using a patterned wafer in the production line as a monitor wafer. In other words, the source of testing is a product wafer instead of a bare wafer, which is used in the prior art. Thus, after some non-destructive tests being carried out, those product wafers used in the tests can be put back into the production line for performing next fabricating process. Therefore, the output of the production line is not affected by those tests. In addition, the method of the present invention can be focused on wafers in different fabricating machines or reaction chambers so as to perform defect control on high risk fabricating machines or reaction chambers hidden in the production line.

After finishing process B 220, a defect detection 260 is performed. As shown in FIG. 4, in the method of defect control in the present invention, a defect inspection 310 is first performed in the defect detection 260. It detects all defects in the wafer by scanning the whole wafer. Then, an automatic defect classification (ADC) 320 is performed for classifying the detected defects according to a predetermined database. The defects are separated into a plurality of defect types according to the setting of the predetermined database. In a preferred embodiment of the present invention, those defects are divided into four defect types, which are a defect type A, B, C, and D, according to their shapes, sizes, locations and some other factors.

It is noted that the predetermined database stores information including all possible defect types for all semiconductor processes and corresponding defect information of each defect type. Thus, after performing the defect inspection 310, the adding defects, which are generated in process B 220, and the underlayer or pre-layer defects, which are generated before process B 220, such as those caused by process A 210, can be separated by comparing the obtained defect information in the defect inspection 310 with those stored in the predetermined database. As shown in FIG. 4, in the preferred embodiment of the present invention, the defect type A, the defect type B, and the defect type C belong to the adding defects caused by the process B 220. Meanwhile, the defect type D belongs to the pre-layer defect that exists before performing the process B.

In the method of defect control in the present invention, the defect information stored in the database includes the influence degree of yield and the main cause of each defect types. Thus, different actions can be taken for different defect types of the adding defects (the defect type A, defect type B, and defect type C) according to their own influence degrees of yield. For example, according to the influence degree of yield of each defect types stored in the database, killer defects, which have a high influence degree of yield such as defect type A and B, and non-killer defects, which have a low influence degree of yield such as defect type C, are separated in the automatic defect classification 320. Thus, some additional actions can be performed to deal with the killer defects in advance. In the preferred embodiment of the present invention, while a killed defect is found, the method of defect control searches the possible root cause in the database according to the detected defect type. For example, the defect type A may be caused by a root cause A in the process B. Then, an alarm 330 is delivered to a corresponding engineer. In the preferred embodiment of the present invention, a defect analysis report is made according to the detected defect type of killer defects and related data, such as the defect type, numbers, locations, and root cause, in the database and delivered to a corresponding engineer by e-mail. Therefore, the engineer can take some proper actions to correct process parameters 340 and solve the excursion case in a very short time. For example, when the database already has enough information for the detected defect type, the engineer can correct the process parameters directly according to the information provided by the database to prevent these defects from occurring again in the next batch of products and judges to abandon or rework this batch of products. If there is not enough information in the database, a manual defect analysis is carried out and the database is updated according to the result of the manual defect analysis.

Since the method of defect control in the present invention uses a patterned wafer as a tool monitor, no bare wafer is needed in daily check, leading to a reduction in the amount of the required bare wafers. In addition, since the product wafers online can be used for testing, there is no limitation in scale for sampling. In other words, all of the product wafers online can be used as testing sample according to the production situation. Thus, the possibility of detecting the occasional excursion case can be greatly improved and the defect analysis can be carried out to solve the problem of the occasional excursion case. Moreover, the integrating defect is not easily detected in the prior art. Even if it is detected, it is still hard to judge which process is the source of the problem. If the engineer is forced to judge in a very short time, wrong judgment is easily made in the defect analysis. Otherwise, for improving the reliability of the defect analysis, a lot of time and effort is necessary to perform a large scale of examination for finding the correct root cause. However, a database is utilized in the present invention to assist the engineer with analysis in advance. Thus, the root cause of defects can be judged quickly and correctly and some actions, such as correcting the process parameters, can be performed properly to solve the defect problem.

It is noted that the method of defect control in the present invention includes a step of automatic defect classification. There are many defect types. Some of them have great influence on the process yield, but some of them do not affect the process yield. The key defect types of each process are different. Thus, with the assistance of the database and the automatic defect classification tool, the prelayer defects, killer defects, and non-killer defects can be separated in the step of automatic defect classification. In comparison with the prior art, one defect scanning process can be skipped since the method of the present invention does not have the pre-scan process. This leads to reduction in the defect scanning work of the defect detection 260. It also lets the engineers focus on the killer defects instead of wasting time and effort on the non-killer defects. The loading of the SEM review can be reduced effectively so as to speed the response time of the defect analysis.

Since the ADC tool used in the present invention can reduce the loading of the defect detection effectively, the method of defect control in the present invention can be applied to plenty of semiconductor processes to monitor all high risky processes, such as the process B, individually. In other words, the sampling examination by grouping in the prior art can be improved. In the present invention, the defect detection 260 can be performed directly after the process, which is predetermined to be monitored, is finished. In comparison with the prior art method, which performs the defect detection after several semiconductor processes are finished, it is obvious that the sensitivity of the method of defect control of the present invention can be improved greatly.

In comparison with the prior art, the method of defect control in the present invention uses the inline product wafers for testing so that the bare wafer is not required in the daily check, leading to reducing the usage of the bare wafer and improving the throughput. In addition, for the excursion case and the integrating defects caused by a plurality of semiconductor processes, the method of the present invention is more sensitive. With the assistance of the database and the ADC tool, the response time of the defect analysis and elimination can be speed up effectively, effectively reducing the fabrication cost of the semiconductor wafer.

Those skilled in the art will readily observe that numerous modifications and alterations of the device may be made while retaining the teaching of the invention. Accordingly, the above disclosure should be construed as limited only by the metes and bounds of the appended claims.

1. A method of defect control of a semiconductor process comprising following steps:
providing a patterned wafer comprising a plurality of first defects;
performing a semiconductor process which forms a plurality of second defects on the patterned wafer;
performing a defect inspection to detect the plurality of first defects and second defects; and
classifying the detected defects into the first defects and the second defects and separating the second defects into a plurality of defect types according to a predetermined database.

2. The method of claim 1 wherein the database comprises a classifying rule of each defect type and defect information of each defect type.

3. The method of claim 2 wherein the defect information of each defect type comprises an influence degree over a yield of the semiconductor process of each defect type.

4. The method of claim 3 wherein the method further separates the second defects into killer defects and non-killer defects according to the degree of the influence degree over the yield of the semiconductor process after classifying the defects.

5. The method of claim 4 wherein when killer defects are detected, the method further comprises following steps:
performing a root cause analysis according to the defect type of the detected defects; and
informing a responsible person of the semiconductor process to correct process parameters of the semiconductor process.

6. The method of claim 1 wherein the method utilizes in-line automatic defect classification (ADC) tools to classify the defects.

7. The method of claim 1 wherein the patterned wafer is an in-line product wafer.
